(19) United States
(12) Patent Application Publication
(10) Pub. No.: US 2026/0099775 A1
(43) Pub. Date: Apr. 9, 2026

(54) SYSTEM AND METHODS FOR DATA MESSAGING FOR GLOBALLY MANAGING SEGREGATED RESERVATION DATA

(71) Applicant: STREAMPOINT SOLUTIONS INC., Toronto (CA)

(72) Inventors: Avraam ZOSIMADIS, Toronto (CA); Dharmesh DAYABHAI, Toronto (CA); Jonathan BRUCE, Toronto (CA); Jan Gabriel ONA, Toronto (CA); Peter SYMANIW, Stoney Creek (CA); Paul Andrew BIRKBECK, Barrie (CA)

(21) Appl. No.: 19/352,420

(22) Filed: Oct. 7, 2025

Related U.S. Application Data
(60) Provisional application No. 63/704,461, filed on Oct. 7, 2024.

(51) Int. Cl. G06Q 10/02

(52) U.S. Cl. CPC G06Q 10/02

(57) ABSTRACT

A machine learning based computing system that is configured for rendering, at run-time, improved graphical user interfaces showing a combination of static contracted inventory and dynamic shared reserve inventory. A machine learning data architecture is maintained and trained to generate time-based decay logit outputs that are populated into an extended data structure representing available offers for re-allocating reservation data objects in the dynamic shared reserve inventory. At run-time, the graphical user interface renders a combined view that utilizes the time-based decay logit outputs to generate a rendering showing a constrained view of available offers for potential re-allocation of the reservation data objects.

CROSS-REFERENCE

This application is a non-provisional of, and claims all benefit, including priority to, U.S. Application No. 63/704461, filed 7 Oct. 2024, entitled SYSTEM AND METHODS FOR DATA MESSAGING FOR GLOBALLY MANAGING SEGREGATED RESERVATION DATA. This application is incorporated by reference in its entirety.

### FIELD

Embodiments of the present disclosure relate to the field of machine learning and data structures, and more specifically, embodiments relate to devices, systems and methods for improved data management by utilizing automatic dynamic opportunistic rebalancing between segregated silos of segregated data objects.

### INTRODUCTION

Managing data objects within a platform is a technical challenge that arises in respect of coordination middleware platforms that support registration and reservation process front-ends. In particular, specialized analytics systems are often used to process interactions and provide insights into engagement and user data metrics. However, these systems are typically isolated and may require specific data structures in order to adapt to dynamic event environments that are constantly fluctuating as bookings are made and cancelled. Rebalancing reservations is a non-trivial challenge due to technical segregation mechanisms between reservation inventory.

### SUMMARY

A technical challenge with inventory management for event administration is that alongside the contracted inventory held within the system, third party servers containing unique data structures and inventory may need to be interacted with in real time. A reservation platform is faced with aggregating a plurality of data structures across multiple events and inventory sources and transforming the data structures into actionable inputs which can be used to drive future decisions within the system. Therefore, an improved inventory management system and method which responds to dynamic conditions by globally managing segregated data amongst a plurality of event administrators and third party servers is proposed for more efficient computer resource usage and data visualization.

A platform is proposed that provides a reserve block inventory, the platform configured to operate as an automated crossing network between different siloed user accounts of the platform, where the different siloed user accounts are able to indicate, publicly or privately, availability for trading reservation allocations of a shared reserve block. The shared reserve block can be combined with availability of a contracted block to provide a combined graphical user interface.

A technical challenge with the reserve block inventory is that there is open competition between booking entities, and a level of uncertainty as to whether a room is actually available for booking at a particular price, particular location, particular hotel and particular room type, as the open offers may not be publicly available and only open for confidential crossing. A particular offer may be taken up by a corresponding bid by any party, and may no longer be available for a subsequent bid. Even though a coordination system indicates that there is a potential crossing set of offers available, it may not always be actually available because the reserve block allocated for a particular userspace prioritizes local reservations first, and thus there may be staleness in the available crossing offers shown, and this staleness is exacerbated by elapsed time from when the last set of offers were polled from each of the underlying userspaces or accounts. Accordingly, issues with phantom inventory can arrive.

Accordingly, in the proposed platform that operates as a crossing network, the system is also configured to provide an improved graphical user interface that is generated based on machine learning based time decay and probabilistic availability factors in a computational effort to more accurately estimate availability since a last poll of available reservation offers from each of the underlying user accounts. Accordingly, an improved decision making interface is provided that is configured to utilize a trained machine learning architecture data model to generate metadata values that are appended into an augmented data structure.

Analogous availability for contracted block inventory options are then stored as heterogeneous data objects are stored on an augmented database table that is extended with additional columns and fields to represent a greater entropy level associated with the shared reserve block inventory. A race condition can arise when multiple parties are interested in a same booking at the same time. The improved dynamic augmented backend data structure representation for combining contracted inventory and shared reserve block inventory is proposed for more efficient computer representation and interactions thereof of the heterogenous inventory. The data structure is augmented using machine learning to add time-varying learnable factors that are then used to generate a more accurate graphical user interface rendering. The incorporation of machine learning and specifically augmented time-decay variables as metadata data structure fields is useful for run-time estimation of dynamic values for improving the generation of the user interface elements, taking into account the elapsed time and staleness since an offer was posted into the system and ostensibly made available for acceptance via a crossing bid data message.

In some embodiments, the system is configured to automatically identify booking and cancellation processes through automated website crawls or interface queries, and the system updates a backend model corresponding to transient availability.

Monitored interaction data with the platform is utilized to modify adjustment factors that are associated with the monitored or estimated entropy levels to provide a second input that is indicative of potential velocity of bookings and potential user behavior. Interactions are anonymized and vectorized to train a machine learning model as aggregate data sets.

The anonymization and vectorization assists with establishing improved privacy between different unaffiliated users of a platform, and the approach adheres to local privacy laws. In some embodiments, consent is obtained from users who permit their interaction behavior to improve the accuracy of the machine learning backend system. The second input can be used to determine, for example, a demand surge velocity value based on the tracked user behavior of other users, converted into vector form.

Where availability is transient and may vary depending on booking volumes of supply and demand, the dynamic augmented backend data structure representation includes time-based and probabilistic data fields that are periodically updated and modified based on time-based delay and updates in probability of availability.

The dynamic augmented backend data structure representation is updated through periodic polling, and the input data sets from a crawler are provided to a backend machine learning model, which is configured to periodically update the time-based and probabilistic data fields with estimated logit values obtained from operating the backend machine learning model in an inference mode.

The backend system can be configured to expose the combined data table on a graphical user interface so that a hybrid representation for combining contracted inventory and shared reserve block inventory to show a greater availability and flexibility of reservations. The combined data table includes machine learning generated field values corresponding to existing inventory that is adapted to reflect reduced inventory at a price range after a period of time has elapsed since the polling/timestamp of the most recent set of offers.

Upon receiving a booking request, the system is configured to interrogate the combined data table to route data messages accordingly to generate a hybrid booking utilizing a combination of contract block inventory and shared reserve block inventory.

When generating a hybrid booking, the time-based and probabilistic data fields are utilized to determine whether the system will automatically make opportunistic reservation messages, which in some cases can include a combination of refundable, semi-refundable, or non-refundable bookings, depending on the system's expected demand for the hybrid booking, for example, which can be based on a determined velocity of booking confirmations and/or cancellations.

The time-based fields are automatically updated using the machine learning model, which imparts a machine learning based time-decay factor and adjustment to more accurately gauge time-based signals in booking/availability behavior. In some embodiments, external reservations are made to add additional shared reserve block inventory, and the system can be configured to externally obtain establish and/or cancel reservations to hold availability by the system, and in some embodiments, the system is able to determine equivalent bookings to provide alternative bookings in the event that availability is no longer available. This can be used, for example, when reserve block inventory has fallen below a threshold value.

In some embodiments, the system is configured to utilize booking APIs or other mechanisms to keep rooms open for a period of time so they can be put in the system in a form similar to contracted inventory.

In another embodiment, the system is configured to poll/probe APIs to try to accurately gauge inventory and availability, and measure trends to predict whether a possible reservation is available.

The system is practically implemented either as a monolithic system or a number of microservices that communicate via remote procedure calls (RPC) and queues. The system can include a special purpose machine operating as a computer server or a connected set of computer servers, and an interface can be hosted behind a web API, providing a backend computing platform coupled to a user interface that renders visual interface elements that is usable for generating and tracking bookings.

As described herein, the backend computing platform is configured for automatic aggregation of multiple room sources (in block or shared reserve block) to assemble reservations from a multitude of shared reserve sources, and an improved reservation aggregator engine is proposed that is configured to utilize a variety of data points to first establish equivalency through machine generated estimations, and potentially pre-purchase rooms at lower costs (hotels may modify prices as rooms fill up).

In some embodiments, the system is configured to access datasets representing events currently in the pipeline and their estimated attendance, currently available inventories and the current sales uptake (how inventories for the required days has decreased recently), historical seasonal trends and world events.

All of this information in the input data sets can be used to both train and utilize for inference a machine-learning model that is configured to predict which rooms the system can book in advance, and the outputs can be used as output logits for generating one or more pre-bookings or hold requests. As there can be different hold and cancellation options available through the APIs, the system can automatically be configured to operate as an agentic pre-booking engine to opportunistically establish holds and cancellable reservations in an effort to reduce overall costs.

The model is periodically retrained using current data and the system is configured to retrain the machine learning model such that the system is able to automatically adjust and optimize based on incoming data. A graphical user interface interacts with the back end via a web API and can be implemented, for example, as an SPA (single page application). The room block store and associated extended metadata can be stored in a relational database, for example, with extended metadata fields and tags for improved computing fields pre-determined and calculated for the decision support interface.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a block schematic diagram of an example system for globally managing segregated reservation data, according to some embodiments.

FIG. 2 is a user interface diagram of a platform management display that is accessible by an administrator, according to some embodiments.

FIG. 3 is a user interface diagram on an output display of a user device which displays an actionable data structure representation, according to some embodiments.

FIG. 4 is a schematic diagram of a computing device such as a server, according to some embodiments.

FIG. 5 is a schematic diagram of the automated crossing network for shared reserve inventory, according to some embodiments.

FIG. 6 is a block schematic diagram of an example system architecture for combining in block and shared reserve block inventory and corresponding adapters, according to some embodiments.

FIG. 7 is an example machine learning backend configured to support the system shown in FIG. 6, according to some embodiments.

FIG. 8 is an example interface showing a dynamically generated decision support interface with intermingled contracted block and shared reserve block inventory interactive graphical data objects, according to some embodiments.

### DETAILED DESCRIPTION

A technical challenge with inventory management for event administration is that along side the contracted inventory held within the system, third party servers containing unique data structures and inventory may need to be interacted with in real time. Essentially, a reservation platform is faced with aggregating a plurality of data structures across multiple events and inventory sources and transforming the data structures into actionable inputs which can be used to drive future decisions within the system. Therefore, an improved inventory management system and method which responds to dynamic conditions by globally managing segregated data amongst a plurality of event administrators and third party servers is proposed for more efficient computer resource usage and data visualization.

An improved dynamic augmented backend data structure representation for combining contracted inventory and shared reserve block inventory is proposed for more efficient computer representation and interactions thereof of the heterogenous inventory. The heterogeneous data objects can be stored on a common database table that is extended with additional columns and fields to represent a greater entropy level associated with shared reserve block inventory, reflecting that the shared reserve block inventory may be interacted with by other parties on the platform and that accordingly, a level of the shown inventory is phantom inventory. Increased estimation accuracy allows the system to provide an improved decision support interface using dynamically adjusted parameters.

Real time interaction with dynamically shifting inventory is challenging, as inventory changes at a rapid pace. The system is configured to periodically poll application programming interfaces associated with one or more inventory management systems of a reserve inventory allocation system to determine an inventory level of available offers, and this inventory level can be used to automatically increase or decrease a size of a virtual buffer of availability that can be made available on-demand. In some embodiments, as described herein, the virtual buffer is established through linked accounts that are linked at a backend level to establish a dynamic pool of availability for a particular event. The virtual buffer can be shared across multiple parties and accessed as required, and in some embodiments, the virtual buffer is established using re-allocatable reservations as between different groups.

A matching engine can be provided that re-allocates reservations in accordance with one or more dynamic matching rules, and parties may be able to indicate the rules upon which their existing reservation inventories are made available to the virtual buffer/dynamic pool, and similarly, other parties may be able to indicate the rules in which they would automatically obtain reservations from the virtual buffer/dynamic pool. In some embodiments, the matching engine further automatically generates reservation and cancellation requests to manage a size of the virtual buffer/dynamic pool, opportunistically reserving inventory when the system automatically determines that pricing is favorable or there is expected demand. In some embodiments, the system is configured to automatically queue and coordinate reservation requests to manage pricing behavior.

When making reservations, an entity is able to designate a first portion of the booking as a solid booking, while a second portion of the booking is designated as an opportunistic booking that is an allocation on a shared reserve pool. The shared reserve pool, in some embodiments, can be reservations that are made in the name of a common entity instead of the individual entities (e.g., booked on behalf of the booking platform provider), and can be dynamically allocated and/or re-allocated as between different participating parties. The parties may have reservation systems that are interconnected with a centralized booking platform provider, and the shared reserve pool allocations can also be coupled with data objects or data values indicating automatic rules or conditions upon which the allocation can be re-allocated to another party (e.g., if a premium price is agreed upon, or if a certain time has elapsed). These reservation types are maintained differently on the system backend, and the system is configured to automatically monitor and refresh inventory monitoring systems as well as existing bookings to modify how corresponding reservations for the opportunistic bookings are made. In some embodiments, the opportunistic bookings are not made in respect of the particular user account, but rather, represent an allocation from a shared liquidity pool of reservations that are automatically right-sized as required. The pricing of the particular reservations of the liquidity pool can be adapted and managed as between the different entities that are operating the pool together.

A benefit of this approach is that a user is able to access more inventory than otherwise statically contracted, or a party is able to contract less contracted inventory to account for potential overbookings, and instead, dynamically upon an overbooking scenario, attempt to request additional reservations from the booking system through automatically communicating bids to other parties. When a bid is confirmed and a corresponding offer is located, the reservation can be automatically re-allocated by the system to the bidding party, and corresponding funds may be transferred to the offering party. Some offers may be publicly visible, while other offers may be confidential and only when a bid is broadcast, the system will cross and match the bid if there is a corresponding confidential offer. Confidentiality in offers is useful when, for example, a party does not wish to publicly reveal a potentially decreased attendance at an event, but still needs to offload reservations.

The system, in some embodiments, is configured to use machine learning to proactively re-size and re-price the liquidity pool, based on observed booking momentum and search factors among pool participants or platform users. In this scenario, a number of offers may include a level of price flexibility or pricing conditions, such as at least a 5% premium, etc.

Accordingly, from a front-end graphical user interface perspective, shared reserve block inventory interface elements and indications are provided alongside contracted inventory as equivalent booking options, and the user may interact through a graphical user interface to access and make both contracted and shared reserve block reservations. Each booking is tied to the event, simplifying audits and ensuring precise tracking, as shared reserve block inventory and corresponding bookings are directly connected and managed as part of the associated event data. As the shared reserve block inventory is not always available, the system is configured to modify and constrain the inventory based on machine learning outputs to add a time-varying factor in the generated visual interface elements, based on logit outputs from a machine learning model optimized using a loss function for accuracy relative to a training set of known labels from previous booking attempts. An ongoing corpus of data can be obtained and used for retraining to improve the accuracy of the system.

Contracted inventory can be held and managed within a platform as it is a fixed object that has static availability and price since it is not impacted by external/third party actors. Contracted inventory can include confirmed reservations for a specified number of rooms or guests. Contracted inventory can be represented as statically available inventory that will be available in the backend data structure.

Under contracted inventory, an administrative user can enter a contract to block off a pre-determined quantity of inventory which is then held within a listing which is linked to the platform within a global distribution system. Shared reserve block inventory on the other hand is a dynamic inventory in which availability and price may change within a short time-frame. The shared reserve block inventory can be interacted with through an API, and periodically polled to obtain one or more datasets indicating the amount of current inventory offers, the latest prices, and booking options (e.g., refundable, non-refundable, refundable after a certain date).

The dynamic nature of shared reserve block inventory causes potential issues where a user may attempt to book a shared reserve block object which is no longer available on the third party server, which can occur due to the open and competitive characteristics of using a crossing network computing mechanism for resolving bids and offers. Due to the heterogenous characteristics of contracted and shared reserve block inventory, they are kept separate such that contracted inventory is available within the internal platform and then the crossing network mechanism is integrated to make shared reserve block inventory available in overflow situations. A challenge with shared reserve block inventory is that the data records being maintained may quickly become stale and phantom availability and pricing is possible, especially during periods of high volatility, or demand. Conversely, availability can increase in response to changes in environmental conditions, such as a concert or an event being cancelled due to a performer's scheduling changes.

Inventory, for example, can be obtained from a crossing network API that provides programmatic access to exposed offer availability data, as well as specific offer characteristics, such as property performance data, listing characteristics, listing availability, pricing, and these can be returned responsive to query messages. For example, a crossing network API may be used to obtain current availability of various rooms and booking options. For each available room or room type, the API, once queried, may make available a time-stamped XML file corresponding to the characteristics of that particular room or room type for an offer, and the corresponding price, as well as any promotions, rate modifications, optional charges, among others. It is important to note that the time-stamped XML file that is generated in response can become stale as there are dynamic changes in availability. Accordingly, a same room or room type may be re-priced as rooms become less available. In areas with limited inventory or durations of time where there are multiple large events taking place, the stale-ness of inventory can occur quickly.

The proposed system and method provides the ability to combine the heterogenous data objects of contracted and shared reserve block rooms into a single augmented data structure which can be presented to a user in a seamless interaction. Effectively, shared reserve block and contracted inventory can be shown together as “inline hybrid bookings”. The platform contains a set of crossing network APIs which communicate with a global distribution system that contains available contracted and shared reserve block inventory. The global distribution system is configured to operate with third party servers to pull contracted and shared reserve block inventory into a single environment by periodically polling the crossing network APIs to obtain inventory information at various points in time. The proposed system extends data objects corresponding to each room type with additional machine learning based adjustment field variables, as described herein such that the system is able to show availability that is a combination of the contracted and shared reserve block rooms, and constrain the availability based on machine learning based time parameters.

The machine learning based adjustment field variables are used to establish estimated equivalency with static availability of contracted inventory such that all of these options can be provided together in a decision support interface. Machine learning provides a non-deterministic approach for estimating non-linear relationships between environmental data to provide a proxy mechanism for accurately estimating diminished availability through observations in a corpus of data. These proxy mechanisms are then appended to a data structure and used at run-time to generate the updated graphical interface elements to indicate the estimated constrained inventory of shared reserve block available reservations.

The contracted and shared reserve block inventory is stored within a non-transient memory which structures the heterogenous data objects within a data table which is expandable in order to compensate for the dynamic characteristics of shared reserve block inventory. The data table provides an augmented data structure which is composed of a single storage format so that a user can seamlessly view available inventory within one platform, regardless of whether it was contracted or shared reserve block. The dynamic augmented backend data structure representation includes time-based and probabilistic data fields, as well as trainable data fields that are used to represent data elements.

The dynamic augmented backend data structure representation is used to establish equivalency with static contracted block inventory such that the graphical user interface and reservation system is able to provide a consolidated view to users based on a computer generated estimation of real availability and pricing based on machine learning based automatic adjustments, providing an improved decision support interface for users.

The automatic modifications on the backend are conducted periodically to optimize the adjustment factors such that the adjustment accuracy is improved over time. In some embodiments, platform usage of the system is also utilized as an adjustment factor in determining equivalency. The machine learning model and time-decay based probabilistic approaches are utilized to account for both a staleness since the time-stamped poll data, as well as potential decay speed due to environmental factors, automatically accounting for surges in demand or changes in availability using the machine learning generated time-decay value as a proxy.

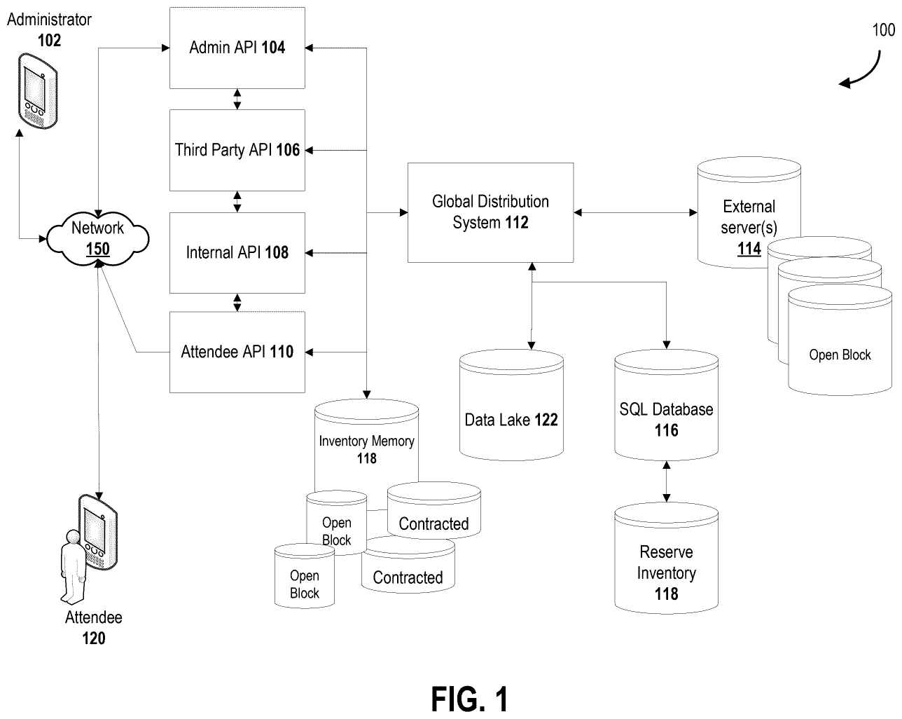

FIG. 1 is a block schematic diagram of an example system 100 for globally managing segregated reservation data. System 100 may include one or more processors coupled with one or more memory devices. System 100 may be connected to a cloud based network 150 in some embodiments.

System 100 may be used for event management such that an administrator 102 may generate room blocks composed of a pre-determined number of contracted rooms which are reserved for attendees of an event. The administrator 102 may further input a group of hotels into system 100 which contain contracted inventory such that the system 100 can use this information when pulling shared reserve block inventory from third party servers 114. System 100 may be configured to contain a set of logic rules which determine the data representation presented to an attendee 120 who is looking to interact with the system 100 for the purpose of making a reservation. The set of logic rules may be input by the administrator 102 or be a default set of rules which are generic across the entire system 100.

System 100 may generate a set of shared reserve block and contracted inventory which can be reserved by an attendee 120. By combining shared reserve block and contracted inventory into a unified data structure representation within the platform, the attendee 120 will be provided with a plurality of booking options which may retain the attendee 120 within the platform even when contracted inventory specific to an event are no longer available. This may result in the attendee's 120 interaction data being captured by system 100 and stored within the system. Further, once an attendee 120 has made a reservation within system 100, they will now be captured within the platform which may lead to further interactions within the platform related to the event.

For example, once attendee 120 has made a reservation within system 100, they may now be provided with further actionable items related to the event corresponding to their reservation. This may include car rentals, flights, event itinerary, nearby attractions, discounts, and the like. Therefore, the ability to retain attendees within the platform results in further interactions, which leads to further user data being captured which can be used to improve downstream user experience. Further, by capturing attendees within the platform, revenue from the reservations flow back to the event administrator rather than third party platforms which have typically been used by attendees when contracted inventory has filled.

System 100 may also provide the administrator with the ability to structure specific platform rules for different user groupings such that specific attendee types are provided with tailored pathways within the platform. System 100 may also provide the administrator 102 with the ability to create and modify sub blocks within the booking contracts which provides improved insights into trends and patterns arising from the existing reservations. Administrator 102 derives a significant benefit from having all attendees 120 captured within a single platform as it provides a cohesive data set that can be used to monitor and analyse inventory attrition, event statistics and additional revenue opportunities.

In this situation, an administrator may wish to ensure that attendees can still book housing which is identical/similar to the contracted rooms. This will require the platform to provide a seamless combination of contracted and shared reserve block inventory (“inline bookings”) to an attendee who can select the necessary booking options without having to leave the platform to find available inventory on third party servers. As described herein, a problem with shared reserve block inventory is that the inventory is not always truly available, and there are issues with fluctuating prices and availability that cause a level of inaccuracy or staleness in booking.

When trying to submit a booking request through an API, for example, the prices may no longer be accurate and/or the booking may simply be refused due to changes in availability. A danger of providing inline bookings through a computing interface is that it is desirable to avoid a situation where the interface shows an unrealistic availability due to stale availability estimations from polled data from external APIs.

Being able to identify or estimate changes in availability is very important, as there are impacts on user experience as well as platform stability. As described herein, system 100 is configured for maintaining an additional backend data structure that is extended to include specific probabilistic and time-decay metadata fields to provide an improved decision making interface for users when the users are assessing the availability of inventory in the system, whether the inventory is contracted blocks or shared reserve blocks.

The system is designed to automatically constrain how much inventory is shown in the graphical user interface in an attempt to provide a more realistic view. Further, in a further variant embodiment, the system can also be designed to automatically attempt to replenish or add reservations or reservation holds into a contracted block if contracted block inventory has fallen below a particular amount in an attempt to automatically and opportunistically hold a particular price level. For example, the automatic reservations can occur during a time period where contracted rooms have been all booked far in advance of a booking date, the automatic reservations being triggered to establish some level of availability up to a particular cut-off period prior to the event date (to avoid the system booking rooms that cannot be filled).

The probabilistic and time-decay metadata fields are adjusted parameters that include a training factor obtained through monitoring platform usage and/or periodic polling data from the booking APIs such that the adjustments can be made based on observations taken across a period of time. In some embodiments, the adjusted parameters are adjusted based on a machine learning model that is maintained separately on the backend that is trained based on tracked interactions on the platform as well as the periodic polling data from the booking APIs. The machine learning model outputs a series of adjustment logits that are then utilized by the decision making interface when generating visual interface elements for the user.

In one example of system 100, an administrator 102 may set up an event offering within the platform housing system 100. The administrator 102 may have 100 contracted rooms which are available through the platform, and may also set certain logic conditions which control the conditions on when shared reserve block inventory is offered to attendees 120 who are seeking accommodations.

Administrator 102 may provide, as an input, a set of inventory traits to an admin API 104 which are based on characteristics which overlap with the contracted inventory. For example, the characteristics provided to the admin API 104 may include hotel, room type, price, location, dates and the like.

Admin API 104 is configured to parse the inventory traits input by the administrator 102 into instructions associated with an event and which are stored within the global distribution system (GDS) 112. The GDS 112 may be configured to generate pull requests to third party servers 114 which will return shared reserve block inventory which matches the inventory traits.

GDS 112 may submit a pull request to the third party server 114 when an attendee 120 is seeking to make a reservation for an event managed by the administration 102, but the contracted inventory associated with the event is either filled or has minimal availability. The shared reserve block inventory will be combined with the contracted inventory so that the attendee 120 is able to complete their reservation within the platform, regardless of whether the contracted inventory has been filled.

In some embodiments, the administrator may have established logic conditions within system 100 which control when shared reserve block inventory is pulled by GDS 112 and presented to the attendee 120. For example, shared reserve block inventory may be presented to the attendee 120 when a pre-determined percentage of contracted inventory has been filled, or only when all contracted inventory has been filed. In another embodiment, administrator 102 may input conditions that require attendee 120 to reserve contracted inventory even when shared reserve block inventory may be available or even more desirable to the attendee 120. The logical conditions may be stored within database 116 which manages the data flow and processes within system 100.

In another embodiment, administrator 102 may provide a listing of pre-approved hotels which shared reserve block inventory must belong too. In a further embodiment, GDS 112 may pull shared reserve block inventory into the platform only when they meet a set of attendee 120 preferences and conditions. Attendee 120 preferences and conditions may be established from metadata stored within system 100 stemming from previous interactions with the platform or filters selected by the attendee 120. In a further embodiment, attendee 120 preferences and conditions may be determined by metadata stored within system 100 which is associated with a group of users which have overlapping characteristics with the attendee 120.

The shared reserve block inventory which is pulled from a third party server 114 is compiled within a reserve inventory listing 118 which is implemented within the system 100 as a non-transitory memory storage medium. The inventory listing may be configured combine the shared reserve block inventory from the third party servers 114 with the contracted inventory which was compiled from within the system 100.

The combined contract and shared reserve block inventory stored within the inventory listing 118 may be accessible by an attendee API 110 which may be configured to parse the combined data structure and provide a visual representation of the combined data structure to an attendee 120. The attendee API 110 may be configured to receive a request for booking from an attendee 120 through a searchable interface displayed on a user device output. The request may contain metadata which is used by the attendee API 110 in a query to the inventory listing 118 to retrieve combined data structures which satisfy the metadata criteria. In some embodiments, the metadata embedded within a request from a user may include an associated event, a price, duration of stay, type of inventory, accommodation rankings, discounts available, other preferences set by the attendee 120 when making the request and the like.

The data structure representation generated by the Attendee API 110 is displayed on a user device output and may contain actionable data objects which enables an attendee 120 to reserve inventory object. When the attendee 120 completes the reservation, they may be provided with follow on booking options which can be controlled by default rules within the database 116 or by rules set by an administrator 102 which are associated with an event. The follow on booking options may include options to reserve transportation (i.e. car rentals, trains, flights), activities associated with the event or location, upgrades/discounts associated with their reservations and the like.

In some embodiments, the combined data structure representation may be embedded with logic rules which determine how the inventory is displayed, whether contracted, shared reserve block, or both types of inventory are displayed at the same time, how long a specific shared reserve block inventory object is displayed, and when to update the shared reserve block inventory with new offerings. These logic rules may be generated and stored within the database 116 and can be either default rules or rules specific to an event.

By providing a combination of shared reserve block inventory and contracted inventory to an attendee 120, the attendee 120 is captured within the system, rather then migrating to a third party server to complete their reservation. For example, if the contracted inventory is filled or substantially filled, there may be zero/minimal inventory options for an attendee to reserve. By integrating real time shared reserve block inventory availability into the platform, system 100 may allow the administrator 102 to obtain the valuable attendee data and commissions associated with an attendee 120 reservation.

As has been mentioned earlier, there is substantial value in the data associated with an attendee 120 interacting with system 100. From the point at which an attendee 120 submits an initial booking request, to the end of the event, there are countless instances where the attendee 120 may interact with system 100 in a manner that can produce valuable data for the administrator. Therefore, it could be understood why ensuring all attendee reservations are captured by the platform will not only result in immediate user data, but will also result in future user data becoming available that would be lost if an attendee 120 migrates to a third party platform.

Within system 100, an internal API 108 may be configured to collect metadata associated with an attendee's interactions with the platform. In some embodiments, this may include interactions such as the initial booking request, the completion of a reservation, follow on reservations, event attendance, location, duration of stay, event size, attendee cost, hotel location, hotel rating, hotel amenities, hotel cost, external spend (i.e. restaurants, activities, rental cars), and the like.

In some embodiments, internal API 108 may include a listener node which acts to monitor the data flow and retrieve metadata which is associated with attendee interactions.

The metadata associated with attendee interactions may be stored within a data lake 122 configured to store and sort metadata based on users and groups of users. The data lake 122 may sort metadata based on characteristics associated with a user and the event associated with the user. This may allow the sorted metadata to build out traits which are associated with a group of users, and then classify attendees within one or more groups of users. In some embodiments, the metadata within the data lake 122 may be sorted based on traits including user booking requests, event attendance, age, position, gender, external spend, reservation cost, room type, hotel, external activities reserved, and the like. In some embodiments, the metadata stored within data lake 122 may include one or more of site interactions, purchases, attendance, location, travel, reviews, job position, employer and length of visits.

The data lake 122 may be configured to provide access to the filtered metadata to the admin API 104. The admin API 104 may be configured to parse the filtered metadata into specified metrics identified by the administrator 102. For example, administrator 102 may desire to know the expected economic impact of their event, and may be able to view this metric based on the metadata within the data lake 118 which corresponds to the type of event and/or type of users which are associated with their event.

In another embodiment, administrator may obtain metrics on the types of offers/discounts, activities, additional revenue opportunities and attrition rates of their contracted inventory based on the metadata stored within the data lake 118.

It would be understood that the ability to capture broad user data from attendee interactions within the platform leads to a comprehensive view of the economic and user experience metrics which are vital to an administrator 102 in managing their event.

The GDS 112 may be configured to generate for the API 106 a dynamic listing of shared reserve block inventory which satisfies the initial attendee request. The shared reserve block inventory availability is pulled from third party servers 114 and therefore the listing does not have a stable structure since objects can change in terms of availability and/or cost.

In some embodiments, the GDS 112 may pull shared reserve block inventory from third party servers 114 which have been identified by the administrator to match contracted inventory already associated with the event. In some embodiments, the GDS 112 may use metadata obtained from the user request when generating the open-block inventory availability which is stored in the data table 118. Since the user request is associated with an event organized by an administrator, the attendee request will include metadata related to the associated event which will also be used by the GDS 112 when generating shared reserve block inventory availability.

Metadata used by the GDS 112 may include context specific data such as the cost an attendee would like to spend on inventory, location of event, dates of event, duration of stay, type of inventory, accommodation rankings, discounts available, other preferences set by the administrator when making the booking contract.

Once the shared reserve block inventory is pulled from the GDS 112, the internal API 108 is configured to compile the contracted inventory associated with the user request. The contracted inventory is stored within the platform as it has already been put on a hold due to the contract entered into by the administrator. The compiled contracted inventory is transferred to a non-transitory memory storing a data table 118 which is configured for storing heterogenous data objects.

Data table 118 receives both the contracted inventory and shared reserve block inventory as heterogenous data structures. These can include individual XML files that are loaded into the data table 118. The data table 118 is configured to be extendable with additional metadata fields so that the data table 118 can capture the unstable nature of the shared reserve block inventory data objects which were pulled from the GDS 112.

The system functions to parse the contracted and shared reserve block inventory into a single storage format stored in data table 118 such that an augmented data structure is generated. In some embodiments, the metadata fields also include machine learning estimated adjustment factors that are used for dynamic rendering of the graphical user interface elements. For example, there may be fifty contracted block rooms, as well as seemingly one hundred and eighty available shared reserve block rooms at different price points. However, the system is configured to modify the rendering of the availability of the shared reserve block rooms to be able to more accurately reflect a realistic depiction of actual availability of shared reserve inventory offers. In this example, the system, based on monitored booking behavior and historical booking activities, modifies, at run-time when the interface is rendered, the availability of shared reserve block rooms to twenty given a significant rise in booking behavior across the system or a historical pattern of unavailable bookings.

Data table 118 is configured to provide access to the augmented data structure to an attendee API 110. The attendee API 110 is configured to provide the augmented data structure associated with a request from an attendee 102 to a user device associated with an attendee 102. The attendee API 110 generates an augmented data structure representation which is parsed so that it can be displayed through corresponding interactive graphical control elements on the user device associated with the attendee 102.

The augmented data structure representation that is displayed on the user device may include actionable selections which can be triggered through inputs on the interface of the user device. In some embodiments, the augmented data structure representation may be embedded with logic rules which determine how the inventory is displayed, whether contracted, shared reserve block, or both types of inventory are displayed at the same time, how long a specific shared reserve block inventory object is displayed, and when to update the shared reserve block inventory with new offerings. These logic rules may be generated and stored within a database 116 (e.g., a SQL database) which manages and controls the flow of data within the platform.

As a non-limiting example, the augmented data structure representation, according to the rules held within the database 116, may be configured to first present the contracted rooms to an attendee up until the point when all contracted bookings have been filled. At this point, shared reserve block inventory will be presented to the attendee within the same platform. To achieve this, the GDS 112 must pull real time shared reserve block inventory from the third party servers 114 and the data table 118 may expand or contract to reflect the changes in the shared reserve block inventory availability.

In some embodiments, the augmented data structure representation, according to the rules held within the database 116, is configured to present both a grouping of contracted inventory and a grouping of shared reserve block inventory to an attendee's user device display. The grouping of contracted inventory may be displayed as a primary booking option as the platform prioritizes filling contracted blocks, and the grouping of shared reserve block inventory may be displayed as a secondary booking option. In some embodiments, the contracted bookings may be available at a discount due to the bulk discount that was given at the time of purchase. In another embodiment, the contracted bookings may be price controlled to ensure that shared reserve block inventory does not undercut contracted inventory.

In some embodiments, price control may be achieved through a sourcing algorithm stored within the database 116. In some embodiments, the sourcing algorithm may comprise logical rules which exclude shared reserve block bookings that are offered at a lower cost than the contracted bookings. In some embodiments, the sourcing algorithm may comprise logical rules which match the contracted room to a lowest cost shared reserve block inventory object. In a further embodiment, the sourcing algorithm may comprise adjusting the price of shared reserve block inventory to match the price of contracted inventory available for an event.

In another example, the augmented data structure representation may be a hybrid data structure which incorporates a combination of contracted inventory and shared reserve block inventory into a single data structure. For example, an attendee may have submitted a request to book 4 nights at a specific hotel, however the contracted inventory is only available for 2 or 3 of those nights. Under traditional systems, the platform would return a “no availability” message to the attendee. However, under the proposed system 100 and 100A, the attendee API 110 may generate, through instructions from the database 116, a hybrid data structure which contains both contracted and shared reserve block inventory that satisfies the attendee's request. In some embodiments, the attendee API 110 is configured to prioritize generating hybrid data structures of contracted and shared reserve block inventory that share certain characteristics, such as same hotel, same room type, similar price, and the like.

In some embodiments, the third party API 106 may be instructed based on the timer 120 to send repeating queries on a timed schedule. The timed schedule being determined by the estimated hold time of the GDS 112 on the shared reserve block inventory. The repeating queries may include the GDS 112 requesting further information from the third party servers 114 or submitting identical requests to the third party servers 114.

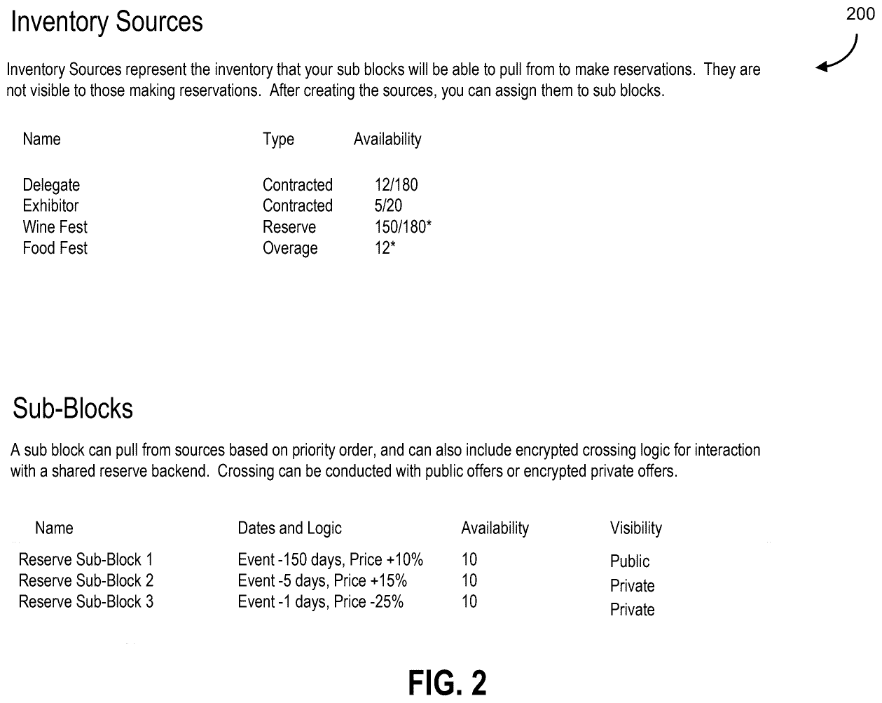

FIG. 2 is a user interface diagram of a platform management display 200 that is accessible by an administrator, according to some embodiments. Display 200 is configured to provide administrator 102 with a comprehensive overview of the inventory blocks associated with their event, including additional revenue sources, attrition rates and event statistics.

In display 200, the initial inventory sources are presented at the upper portion of the display and correspond to inventory blocks which the administrator 102 has created for their event. The inventory sources may be contracted inventory or shared reserve block inventory. As can be seen, contracted inventory contains a maximum limit on availability which cannot be exceed. Therefore, shared reserve block inventory is included within the inventory sources so that once a contracted inventory block is filled, an attendee 102 will still be provide with accommodation options within the platform.

Administrator 102 may interact with the system 100, through admin API 104, to select a listing of inventory sources which each have unique characteristics. For example, administrator 102 may incorporate one or more initial default contracted blocks which will be made available for general event attendees at one or more hotels. The administrator 102 may also generate specific contracted blocks for VIPs, presenters, premium rooms and event staff which can be used to customize the inventory options based on expected attendees.

The administrator 102 may also establish shared reserve block inventory sources which incorporate real time dynamic inventory from third party servers 114 into the inventory pool. The GDS 112 may control the shared reserve block inventory sources, and administrator 102 may input specific rules/conditions on the shared reserve block sources such as hotel, room type, cost, and the like. For example, administrator may have a first shared reserve block inventory source which is configured in the GDS 112 to pull inventory objects from a sub set of third party servers 114 which match both the hotel and room type of a corresponding contracted inventory source. A further shared reserve block inventory source may be generated which is configured to pull any available inventory objects from a broader subset of third party servers 114 which may only match one of either hotel or room type.

Administrator 102 may use the various inventory sources to generate sub blocks which operate under logic rules. For example, administrator 102 may establish a first sub block which will be made available to general attendees. This sub block may initially offer the default contracted inventory up until a pre-determined condition is met, such as the contracted inventory being filled or filled up to a specific percent. At this point, the default shared reserve block inventory source will begin pull availability from third party servers 114 and offering this shared reserve block inventory to attendees 120.

In some embodiments, the sub blocks can also include reserved inventory allocated from the existing shared reserve inventory, but is made available for potential crossing bids by establishing crossing offers on the crossing network platform. The inventory can be used, for example, if there are excess delegates for the party, but if there is another party coupled to the crossing network that requires the allocation and is willing to pay a premium, the reserve inventory can automatically be transferred to their attendee instead. As shown in this example, different logical conditions can be coupled to different sub-blocks, and they may also be coupled with different visibility factors.

In another example, a sub block may include an initial contracted inventory source which is offered to the attendees 102. Once the initial contracted inventory source has become filled, the administrator may structure the sub block so that the GDS 112 may attempt to pull from a first shared reserve block inventory source which matches both hotel and room type of the contracted inventory source. If the GDS 112 is unable to pull any inventory under the first shared reserve block inventory source, then GDS 112 may be configured to pull inventory from a second shared reserve block inventory source which only matches one of either hotel or room type.

The administrator 102 may input logical rules for organizing inventory sources and sub blocks into admin API 104 which stores these rules within SQL database 116. In some embodiments, admin API 104 may be configured to utilize the metadata stored within data lake 122 to generate insights and metrics which can be used to empower decisions on structuring inventory sources and sub blocks. In some embodiments, historical metadata from data lake 122 may be used by an optimization algorithm to modify sub blocks in real time in response to dynamic requests and interactions within the platform.

Display 200 provides the administrator 102 with a detailed overview of the underlying system components, and efficiently combines multiple data structures into a single uniform data representation. The combination of the logical rules stored within database 116 and the ability to dynamically pull inventory from multiple segregated inventory sources provides administrator 102 with increased flexibility to structure their event management platform and capitalize on the data and impact of their event.

In some embodiments, database 116 may be configured to store a recommendation engine containing recommendation logic. The recommendation engine may communicate with the admin API 104 and internal API 108 to provide a cross-contract inventory management recommendation which optimizes inventory availability present within the system 100. For example, recommendation engine may recognize that an event associated with an administrator 102 has contracted inventory sources which have low attrition rates and are unlikely to be filled by the end date of a contract. Recommendation engine may, either automatically or by providing a recommendation to an administrator 102, offload excess contracted inventory to other administrators 102 who are seeking to increase their supply of contracted inventory sources. This may result in contracted inventory sources being shared across multiple events so that the inventory sources are filled. In another embodiment, recommendation engine identifies when an administrator may require an increase in their contracted inventory sources, and in configured to identify potential inventory sources within system 100 that could be utilized to increase supply.

In some embodiments, recommendation engine may be configured to process the metadata stored within data lake 122 and generate recommendations for an administrator. In a further embodiment, recommendation engine may be configured to identify cross-contract inventory sources to replace certain shared reserve block inventory sources which have a low affinity with an administrators inventory preferences.

In some embodiments, recommendation engine may be configured to pull from a supply of globally contracted inventory which is held within system 100. In another embodiment, globally contracted inventory may comprise contracted inventory which became available through a cancellation which occurred within the system 100 under a previous or existing inventory contract. By utilizing a globally contracted inventory source, administrators may benefit when they face either low or high attrition rates. Administrators 102 facing low attrition rates or cancellations may be able to liquify their contracted inventory and avoid wastage. Administrators facing high attrition rates may be able to retrieve additional inventory without facing the open-competition which exists for shared reserve block inventory sources.

In some embodiments, admin API 104 may be configured to offer tranches of globally contracted inventory which can be held for an event in tiers. For example, administrator 102 may instruct admin API 104 to create a first tranche of contracted inventory of 100 rooms at a rate of X per inventory object. Administrator 102 may be able to further create a second tranche of contracted inventory of an additional 100 rooms at a rate of Y per inventory object. This dynamic inventory management feature may allow administers 102 to manage their risk levels and reduce the potential to have wastage of contracted inventory.

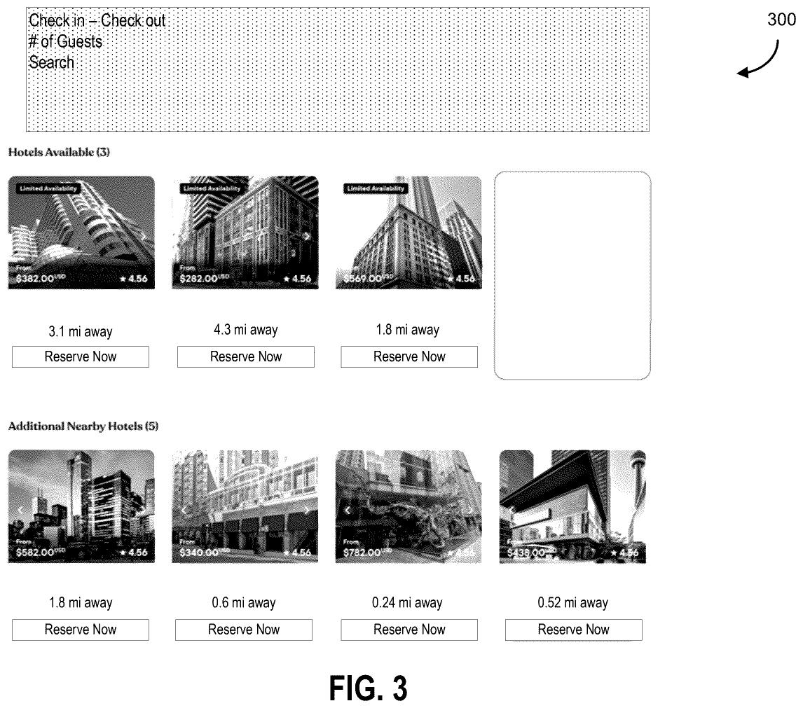

FIG. 3 is a user interface diagram on an output display 300 of a user device which displays an actionable data structure representation.

In output display 300, a user is presented with an interface which contains a search bar which can be used to input user requests and information which will be used to generate the metadata associated with their request. The user request will be associated with an event that is managed by an administrator. Each event will be further tied to a listing of contracted inventory within the platform.

Once a user request is input by the attendee, the third party API 106 will begin the process of submitting a pull request to the GDS 112 to retrieve open block inventory from third party servers 114. The shared reserve block inventory is retrieved based on metadata embedded within the user request and from metadata associated with the event that the attendee is associated with. The metadata may be used by the third party API 106 and GDS 112 to pull shared reserve block inventory which is within a specific price range, within a specific geographic radius, contains contracted inventory associated with the event, has a minimum/maximum rating, has been approved by the administrator and the like.

The output display is generated by the attendee API 110 by parsing the combined data structure of contracted inventory and shared reserve block inventory within the inventory listing 118 into a data structure representation. The display 300 may be coupled to SQL database 116 such that inputs into the user device by an attendee 120 are captured by a listener node which stores associated metadata within data lake 122. The captured metadata may be event or user specific metadata which can be used to identify valuable insights into the specific attendee 120 or their participation in specific events. The metadata within the data lake 122 may be filtered into metrics which can be leveraged by an administrator 102 for future revenue opportunities or improving customer experience. For example, insights generated from the metadata within data lake 122 may be used to create personalized offers and discounts to attendees based on historical data and similarities with other groups of users. Therefore, system 100 provides a database to the administrator which can be used to generate specific rules based on users or types of users.

In another embodiment, metadata within the data lake 120 may be leveraged by database 116 to generate, through a recommendation engine, suggested inventory objects to an attendee 120 at the point of sale. For example, an attendee 120 may be progressing through the payment process and recommendations such as suggested flights, rental cars, activities, rewards, discounts and the like may be presented to the attendee 120 based on their membership within a grouping of users.

Administrator 102 may also leverage the metadate collected through an attendees 102 interactions within display 300 by receiving economic metrics which aggregate the total impact of an event within a city. Database 116 may be configured to generate impact reports based on the aggregated data of all attendee 120 interactions within the platform, these reports can be utilized by an administrator 102 when negotiating hosting future events.

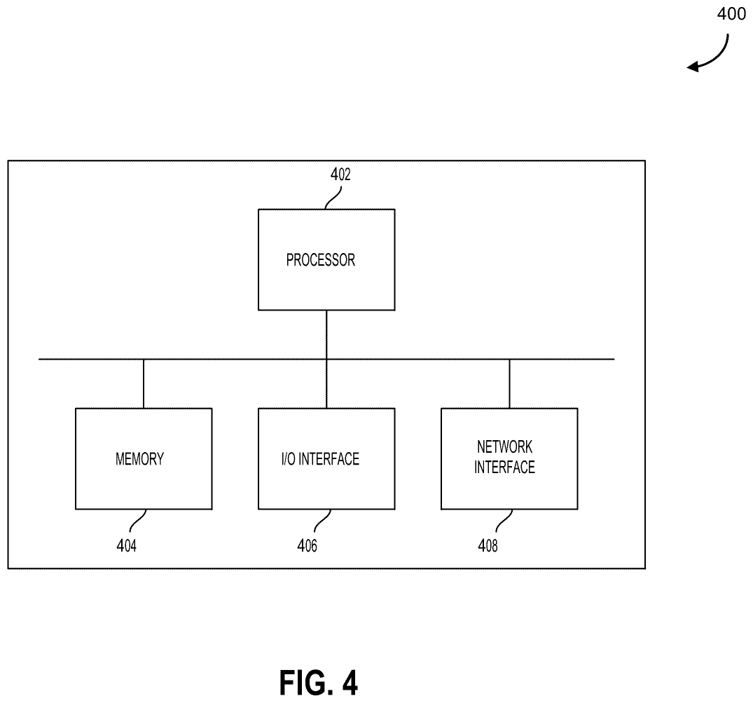

FIG. 4 is a schematic diagram of a computing device 400 such as a server which may implement the proposed system discussed above. As depicted, the computing device includes at least one processor 402, memory 404, at least one I/O interface 406, and at least one network interface 408.

Processor 402 may be an Intel or AMD x86 or x64, PowerPC, ARM processor, or the like. Memory 404 may include a suitable combination of computer memory that is located either internally or externally such as, for example, random-access memory (RAM), read-only memory (ROM), compact disc read-only memory (CDROM).

Each I/O interface 406 enables computing device 400 to interconnect with one or more input devices, such as a keyboard, mouse, camera, touch screen and a microphone, or with one or more output devices such as a display screen and a speaker.

Each network interface 408 enables computing device 400 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others.

In operation, the system and method provides administers with improved insight and metrics regarding user experience and economic impact which lends itself to more informed decisions and additional revenue. Segregated inventory data is combined within a single platform which provides additional flexibility over the traditional approach of relying solely on contracted inventory. Further, the typically isolated processes of data collection amongst multiple booking platforms can be aggregated and integrated within a single platform which leads to an increased depth of data and monetization potential.

As a result of the proposed system and method, attendees who may have migrated to a third party server to complete their reservation will be captured under the proposed system and method. Further, an administrator is empowered to holistically track the entire event experience of an attendee from registration to check-out. The increased amount of user engagement captured by the proposed system and method may also result in generating a more complete picture of the economic metric and impact that an event has on a local economy. Event administrators can leverage these improved metrics to pitch their events to hosting cities, and negotiating better incentives from a potential hosting city.

Lastly, the system and method may provide more efficient inventory management of segregated reservation data originating from multiple sources. This may result in decreased processing power and storage being required to operate the system and method within the platform owners internal architecture.

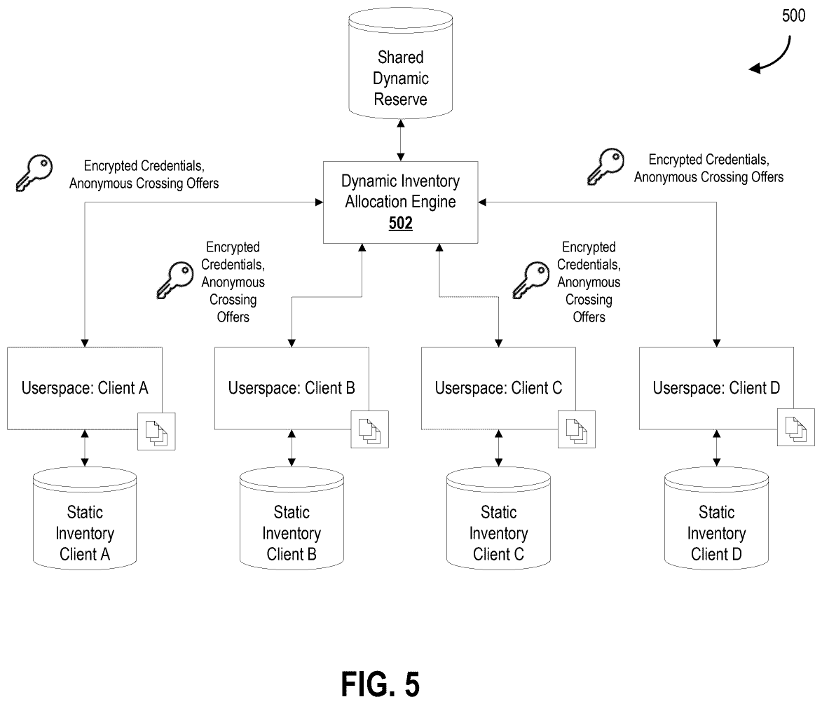

FIG. 5 is a schematic diagram of the automated crossing network 500 for shared reserve inventory, according to some embodiments. As shown in 500, the crossing network is implemented by the dynamic inventory allocation engine 502, which is a computing process operating on a computer server that is configured to host a shared dynamic reserve inventory of reservations for different clients. In this example, there are four participating clients, Client A, Client B, Client C, and Client D. Each have their own corresponding reservation inventory, and are participating in a shared dynamic reserve where a number of reservations are held by the booking platform and can be dynamically assigned, allocated, or re-allocated by modifying corresponding names and personal information associated with a booking reservation.

In this example, Clients A, B, C, and D agree that the reserve should be 40 shared reservations, and the reservations are initially allocated 10 each between each of the Clients. This is in addition to their existing static inventory. For example, Party A may have 30 reservations already in static inventory for potential delegates, and the additional 10 reservations are allocated initially for potential overage, or for potential automatic arbitrage opportunities through the crossing network. Party A may provide as an encrypted data message packet whenever polled by the dynamic inventory allocation engine 502, a structured file indicative of potential offers to sell reservations. The structured file can include characteristics of the reservation, a number of available rooms, as well as whether the offer is visible or should not be visible. The structured file may include encrypted payloads to help ensure that the payloads are not visible to other parties. The dynamic inventory allocation engine 502 may have access to a corresponding encryption key to decrypt the structured file.

In a scenario where Client B has run out of static inventory of reservations and requires additional rooms, Client B may submit a data message including a structured file indicative of a package of confidential bids to request additional allocations from the shared reserve. The structured file indicative of the package of confidential bids are processed by the dynamic inventory allocation engine 502, and where a potential match is found, the dynamic inventory allocation engine 502 is configured to send execution data messages to attempt to initiate a transfer. A transfer may include updating the records of a reservation associated with the shared reserve to reflect the modified booking. A problem that can arise with the crossing network system is that inventory that appears to be available may be quickly rendered unavailable as a faster bid (e.g., by timestamp) has already crossed with an existing offer, and thus the subsequent offer is not able to match with it, or the client has indicated that the offer is no longer available because one of their participants requires the booking allocation and thus the offer is withdrawn from the crossing network or cannot be consummated.

This technical problem causes inaccuracies in what is shown to a client in terms of potential available extended inventory in terms of reservations when a client is using a graphical user interface. Accordingly, as described herein, an improved approach to generating updated inventory estimates showing machine learning adjusted constrained inventory is proposed based on the set of available offers recorded in the system and a time period that has elapsed since the set of offers were recorded in the system.

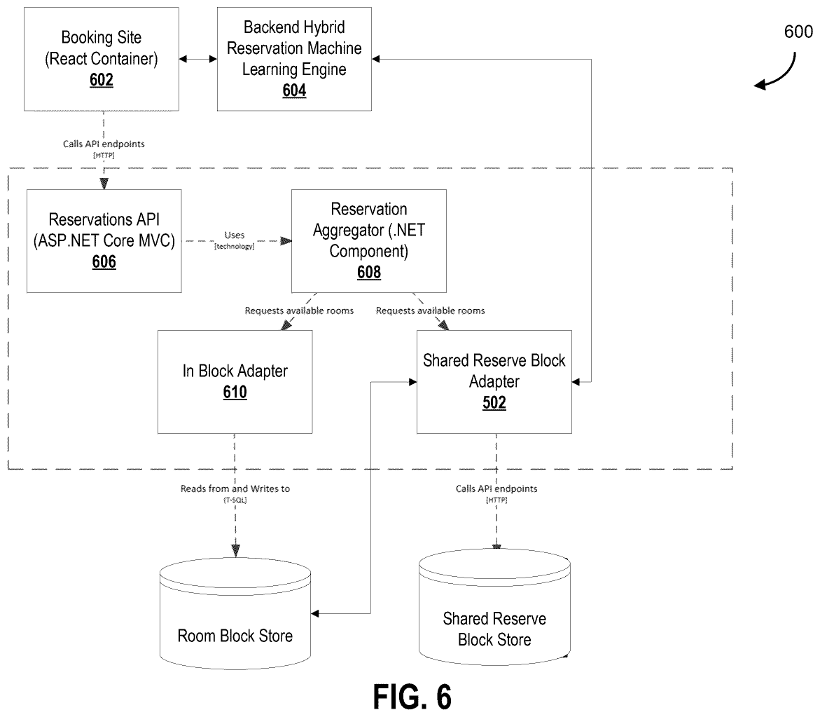

FIG. 6 is a block schematic diagram 600 of an example system architecture for combining in block (contracted inventory) and shared reserve block inventory and corresponding adapters, according to some embodiments.

As shown in diagram 600, a booking site 602 is hosted in a React container that provides a single page application that users can connect to in order to book rooms. The booking site 602 is configured to render a graphical user interface that is rendered on a computing device of a user, and the graphical user interface provides a booking mechanism where the user can use an input mechanism, such as a touch screen or a combination of keyboard and mouse inputs to indicate a selection for a query or to request a booking.

The booking site 602 is coupled to the backend hybrid reservation machine learning engine 604 that is used to render the visual elements of a booking page that combines both available shared reserve block and contracted block inventory availability in accordance with the backend inventory tracker with machine-learning augmented data fields. The booking site 602 is also coupled to a reservations API 606 that is an API endpoint that is used for booking rooms.

When a reservation is made, the reservation aggregator engine 608, which can be a .NET component) is configured to aggregate reservations from multiple sources, and spawns child room request data messages that are sent to an in block adapter 610 and a shared reserve block adapter that is coupled to the crossing network through dynamic inventory allocation engine 502, both of which can be .NET components. The in block adapter 610 may allocate internal reservations by updating an internal booking data structure room block store, which can be a data record in a SQL database to allocate contracted inventory. The shared reserve block adapter is a wrapper that is utilized in conjunction with APIs provided by shared reserve block provider(s) or the dynamic inventory allocation engine 502, which allows the reservation aggregator engine 608 to transmit messages to a plurality of provider computer systems 614 each associated with different shared reserve block sources to make reservations and initiate reallocations. In some embodiments, the crossing network is a centralized computer system. In alternate embodiments, there may be multiple crossing network computer systems that operate in a coupled, distributed architecture.

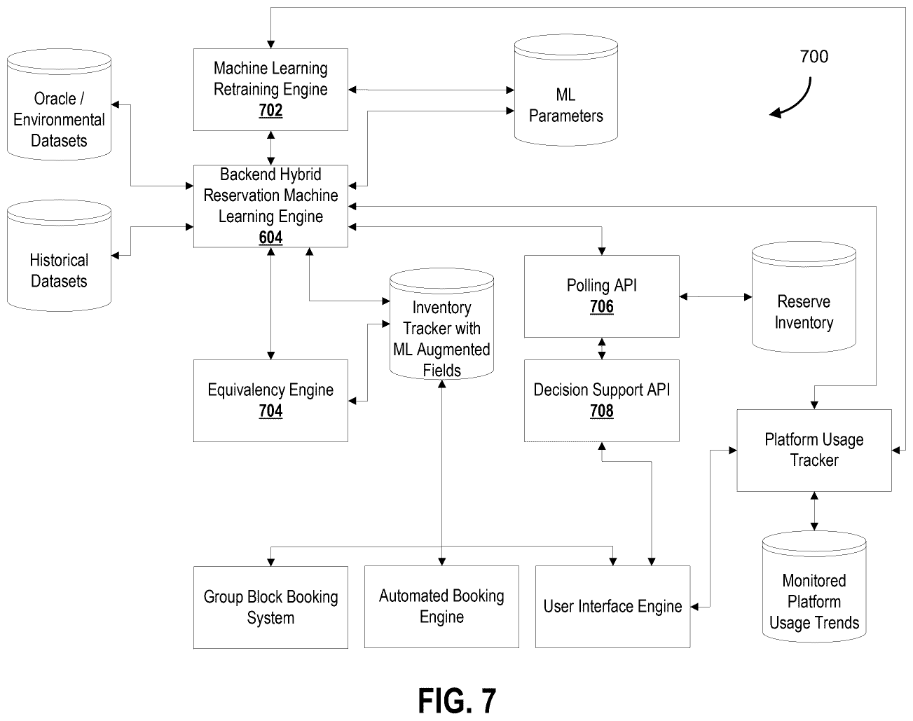

FIG. 7 is a computing diagram that illustrates, in greater detail, the backend hybrid reservation machine learning engine 604, according to some embodiments.

The backend hybrid reservation machine learning engine 604 is coupled to a machine learning model data architecture maintaining machine learning parameters, which can be instantiated prior to usage at default values or with random values. The machine learning model data architecture represents trainable parameters which represent weights and interconnections of one or more hidden layers of interconnected computing nodes (that represent interconnected artificial neurons). The weights and interconnections are used in combination with activation functions to, in aggregate, generate a logit output based on a provided input, the logit output.

The weights and interconnections are iteratively updated through a supervised training phase where the backend hybrid reservation machine learning engine 604 iterates through labelled training data to update the parameters to minimize a loss function.

An example loss function can include minimizing the sum of squared errors relative to a successful chance of booking at a particular desired price point given the location, characteristics, and temporally proximate characteristics associated with a point in time, such as number of events taking place, what date/time of year, among others.

The backend hybrid reservation machine learning engine 604 is configured to access datasets representing historical events, corresponding historical inventories, as well as time-stamped historical data and usage data, which can include platform usage history, such as tracked mouse clicks, page traversals, among others. As new inputs are obtained, these can also be used to periodically retrain the machine learning parameters using machine learning retraining engine 702. In some embodiments, the historical data sets indicative of platform usage are temporally proximate to the time, and the level of platform usage can be measured through a proxy such as a number of tracked search interactions/queries in the associated area, or a number of other booking parties and their activities on the same platform.

Upon being satisfactorily trained, which can include the backend hybrid reservation machine learning engine 604 reaching a pre-defined threshold of accuracy in respect of a test dataset, the backend hybrid reservation machine learning engine 604 can be deployed for usage, and can receive periodically event information of events currently in the pipeline and their estimated attendance, currently available inventories and the current sales uptake (how inventories for the required days has decreased recently), historical seasonal trends and world events.

This information can be received in the form of input datasets that can be mapped to specific input nodes of an input layer of the backend hybrid reservation machine learning engine 604, along with specific shared reserve block inventory objects and their corresponding characteristics. Each shared reserve block inventory object represents a potentially available shared reserve block reservation as represented in a corresponding recorded offer, at a particular characteristic and price. Each shared reserve block inventory object is augmented with additional data fields by the backend hybrid reservation machine learning engine 604 through operation of the backend hybrid reservation machine learning engine 604 in an inference mode using the trained machine learning model data architecture.

For example, a received set of shared reserve block inventory objects may include the following:

Hotel X for CES in Las Vegas area, Jan. 6-Jan. 9, 2026, Hotel Room 1, Non-Smoking, City View, 4.5 Stars, within 0.5 miles of the main event location, average of $255 per night, king bed, 4 rooms available.

Hotel Y for CES in Las Vegas area, Jan. 6-Jan. 7, 2026, Hotel Room 2, Smoking, Garden View, 3 Stars, within 1.5 miles of the main event location, average of $200 per night, king bed, 10 rooms available.

Hotel Y for CES in Las Vegas area, Jan. 6-Jan. 7, 2026, Hotel Room 4, Smoking, Garden View, 3 Stars, within 1.5 miles of the main event location, average of $400 per night, suite room with two queen beds and a sofa bed, 15 rooms available.

The above information can be returned on a periodic polling query along with a timestamped value of when the information was accurate. However, as noted above, a danger of showing crossing network inventory inline with contracted inventory is that the crossing network inventory can have a level of entropy and unpredictability due to fluctuations in pricing and available, especially as other parties may be racing to make the same bookings, or similar bookings may impact availability and if the hotel uses demand based dynamic pricing, may impact pricing as well. For an event such as CES, there are many organizations and many events taking place across the city, and room demand and availability is constantly fluctuating. On the other hand, for a less popular event in a less crowded city, room demand and availability may be more consistent. From an inventory perspective, it is helpful to be able to indicate such demand trends, but deterministic approaches can be difficult to establish computationally given the non-linear relationships between supply and demand, and environmental characteristics.

Accordingly, the data structure is expanded with additional machine learning metadata fields that correspond to estimated price adjustment factors as well as estimated availability adjustment factors, and these price adjustment factors and estimated availability factors can be associated with a time-decay value such that the values are automatically adjusted based on a staleness from the timestamp from when the query result was obtained.

The machine learning engine returns a τ_{price} and a τ_{availability} value that is used to adjust prices and to represent a decay of availability at τ_{price}, respectively. These values are appended to the generated record corresponding to the Hotel Room 1, Room 2, and Room 4as noted above, such that the time period that has elapsed between the polling of the crossing network provider API and the generating of the interface can be used as an input to generate, from the additional τ_{price} and a τ_{availability} values to estimate the adjusted price and availability at run-time. As the inputs into the machine learning engine include characteristics of the proposed reservations as well as locations, the times and dates, the generated outputs can be established on a per room type basis, providing a greater level of granularity. For example, in an event such as CES, larger rooms may be more popular due to the need for exhibitors to be able to prepare in their rooms, and some exhibitors use their rooms for meetings. On the other hand, other events may have a greater trend of popularity for single person rooms, for example.

From a machine learning perspective, the inputs are vectorized and provided into input nodes of the machine learning model and used for inference. The trained machine learning model has output notes corresponding to a price adjustment logit and an availability adjustment logit, which are then normalized and appended into the data structure for downstream use during run-time operation.

If the estimated price is outside of a pre-defined threshold range or the likelihood of availability significantly decayed, the user interface can adjust down the available inventory to reflect a further constrained inventory. For example, if there are originally 50 rooms each, but the machine learning model logits indicate that this is a scenario of high demand and high volatility where there is significant staleness in the polled quotes, it may constrain the showing at run-time to only 5 rooms available each to help ensure that the view provided to the user is more realistic.

The additional data fields that are generated include time-based fields indicative of estimated price stability within a threshold range, as well as expected availability based on a time decay factor from the poll request data load that loaded the shared reserve block inventory object, based on timer values obtained from operating timer 120. For example, the additional data fields can include the estimated modified price, based on the estimated price stability that is different than the quoted price (to automatically take into account pricing drift), as well as a probability of availability at the estimated modified price at a particular time. The additional fields can be generated at interface run-time by the backend hybrid reservation machine learning engine 604 whenever the booking site 602 is accessed to conduct a search of available inventory. At run-time, the time elapsed is then utilized as a factor to further the impact of potential stale inventory, and the generated time variables can be used as a proxy measurement for a velocity of price changes or inventory shrinking.

When the booking site 602 is accessed to conduct a search of available inventory, available contracted block inventory is shown in addition/graphically “in line” with open/shared reserve block inventory that is identified by the equivalency engine 704. The equivalency engine 704 is a computing process that identifies similar block inventory to contracted block options within a pre-defined range of prices and characteristics, such as distance, amenities, and rating, even if the existing contracted block options are already booked and no longer available.

The equivalency engine 704 is configured to limit a number of specific shared reserve block inventory data objects based on an availability time decay metric that is adjusted automatically by the backend hybrid reservation machine learning engine 604 operating in the inference mode. For example, while the shared reserve block adapter 612, when polled by polling API 706 may show an availability of seventy five rooms of room type A being available at a price of two hundred dollars a night, the system may automatically apply an adjustment factor based on booking/search velocity on the platform, new events being introduced into the platform, or previous booking error messages that may adjust the expected room availability down to fifty rooms instead.

The output results are then provided as data messages for decision support API 708 which is coupled with the booking site 602 to provide the constrained set of data objects for available for reservation by the user on the booking site 602. The equivalency engine 704 is a computing process that is configured to identify similar booking availability having similar characteristics within a range of acceptability, as there may not always be a perfect analog to a contracted room type.

Accordingly, the system is configured to automatically tailor and constrain the set of results such that a more realistic depiction of available inventory is presented that is generated on a run-time basis and based on time-decay metrics from a last inventory pull or push from a polled system. A time period is provided to the user to attempt to initiate reservation requests through the reservation aggregator engine 608, which is an automated engine for automatically allocating reservation requests between reservations being made against the available in block reservations at 610, or to be made through the crossing network through the shared reserve block adapter 612. The reservation aggregator engine 608 is configured with different logical rules for allocations as between the available in block reservations and shared reserve block crossing network reservations. In some embodiments, the reservation aggregator engine 608 is configured to prioritize available in block reservations as these reservations may have floor booking requirements to be met. However, different configurations are possible, such as time-duration based prioritizations where for a first duration of time, the reservation aggregator engine 608 prioritizes allocating towards shared reserve block reservations to strategically maintain availability of the contracted block reservations (especially if an event is expected to be very popular and availability is expected to be constrained), and then at a second duration of time, prioritize allocating towards contracted block inventory so that the entire contracted block inventory will be used up to avoid unbooked contracted inventory. Other variations are possible.

In a further embodiment, the reservation aggregator engine 608 is further configured to automatically book reservations autonomously from the shared reserve block adapter in view of expected bookings, and the booked reservations can be automatically triggered when, for example, time decay availability logits generated by the backend hybrid reservation machine learning engine 604 are greater than a pre-defined threshold indicative of rapidly dwindling inventory. The automatically booked reservations can include refundable reservations or held reservations as determined by the equivalency engine 704 as being sufficiently similar to those of the contracted inventory options, and the automatically booked reservations can be added to a reserve of contracted “in block” inventory and allocated by the reservation aggregator engine 608. By automatically generating the booked reservations, the system can be configured to automatically attempt to lock in preferential pricing to support expected over-demand by users of the platform. In some embodiments, the reservation aggregator engine 608 is configured to automatically prioritize the pre-emptive reservations for new bookings, and to re-allocate or cancel holds or reservations as required if there is outstanding availability in the original contracted “in block” after a duration of time while the holds or reservations are still refundable or partially refundable.

Accordingly, the proposed system and method is configured to support a platform which allows an attendee 102 to book a trip within a single interface that contains contracted and shared reserve block inventory, and in some embodiments, the inventory data objects are dynamically rendered and their characteristics are automatically modified based on machine learning-based augmented fields to show a computer estimated realistic view of the combination of inventory, where the entropy and unpredictability of pricing and availability of crossing network shared reserve block inventory is automatically taken into consideration. Accordingly, event administrators are able to gain access to dynamic inventory which can respond to the needs of their event attendees. As a result, attendees who may have migrated to a third party server to complete their reservation will be captured under the proposed system and method. Not only will this increase the commission which flows through the platform to the event administrator, but will also provide a richer breadth of attendee metadata which can be used to improve the user experience of the user and future users who are characterized by the same user characteristics.

The increased amount of user engagement captured by the proposed system and method may also result in generating a more complete picture of the economic metric and impact that an event has on a local economy. Event administrators can leverage these improved metrics to pitch their events to hosting cities, and negotiating better incentives from a potential hosting city.

Lastly, the system and method may provide more efficient computer representation and interactions of the heterogenous inventory. This may result in decreased processing power and storage being required to operate the system and method within the platform owners internal architecture.

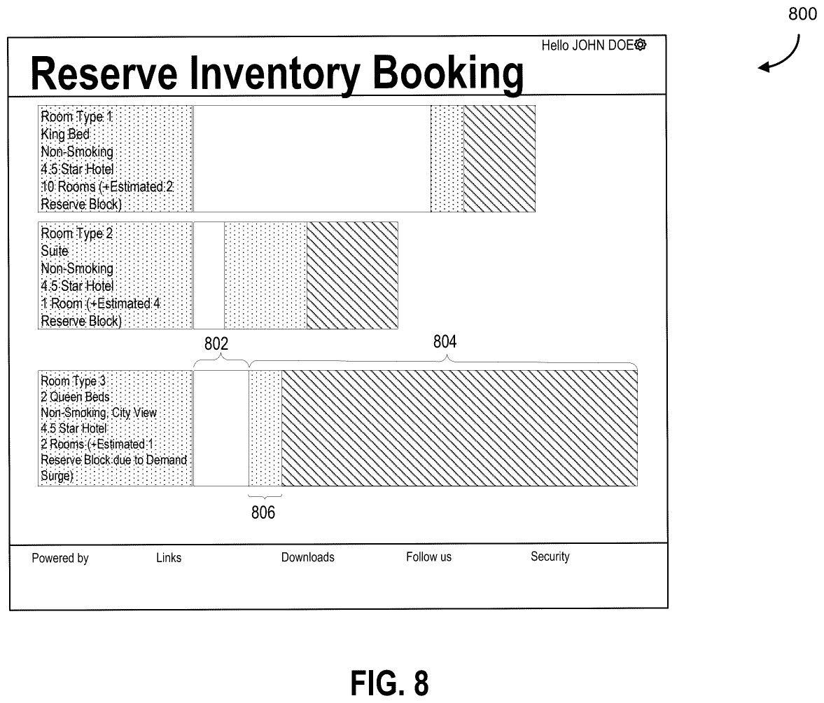

FIG. 8 is an example interface showing a dynamically generated decision support interface 800 with intermingled contracted block and shared reserve block inventory interactive graphical data objects, according to some embodiments.

As shown in FIG. 8, the dynamically generated decision support interface 800 is dynamically generated at run-time when the user accesses the website booking page. In this example, room availability is shown in respect of a Room Type 1, Room Type 2, and Room Type 3. A non-limiting example of the interactive graphical interface elements are shown, and the user may select a particular room type for booking through interacting with the graphical elements (e.g., by clicking on the desired room type and indicating a total number of rooms to be reserved). The contracted inventory is shown graphically using the bars. As shown in the example interface 800, a first bar 802 is shown indicative of the availability of contracted, “in block” inventory, and this is extended through a depiction of the total available “shared reserve block” inventory through crossing network providers that are coupled to the system at 804. As the total available “shared reserve block” inventory may not be indicative of a realistic view of actually available “shared reserve block” inventory, the amount shown in bar 804 is modified and adjusted automatically to establish bar 806, which indicates the constrained section of 804 that is estimated to be sufficiently within the original price range and estimated to be available for booking as time-adjusted based on when the last poll of the “shared reserve block” inventory was and corresponding machine learning logits through operation of the machine learning model in inference. The bar 806 is determined through interrogating the inventory tracker that has been augmented with machine learning based fields that are used to determine the adjustment factors.

As shown in the example for 800, while for each of the three room types, there is some level of shared reserve block availability, the adjusted constrained block inventory representing an improved estimate is less than the full availability. The example for Room Type 3 is provided to show an example where there is high demand or a potential surge as estimated by the system, and this is reflected through a significant decay logit that is in the augmented field that was automatically generated by the system. While for Room Type 3 a naïve poll of the API indicates a large number of rooms, in this example, the system automatically adjusts the view to show that it expects only 2 rooms to be available with a proximate price range due to increased booking entropy that is automatically captured through the machine learning model being operated at run-time when the interface is generated.

This automatic adjustment mechanism is particularly useful in situations where a more accurate view is helpful, such as for conference bookings where there are multiple organizations and/or multiple events taking place in a city or a region, and their booking and reservation activity causing downstream effects on availability in the available offers in the crossing network. Potential attendees would benefit from an interface that not only displays the contracted availability that their organization or organizer has available, but also potentially extended availability of crossing network offers. However, the extended availability has a level of price and/or availability unpredictability, and this is automatically captured and indicated through operation of the machine learning model in inference to provide a useful updated booking interface tool.

When a user interacts with the interface 800 to make a booking either of the contracted inventory or the shared reserve block inventory, the system is configured to record whether the user was able to successfully book, and the price that the user was required to pay, and these recordations are used to establish a retraining data set that are used as a supervised learning training set to periodically re-train and update the weights using the machine learning retraining engine 702. The retraining data set further includes temporally proximate environmental context variables, in some embodiments.

In a variant embodiment, the reservation aggregator engine 608 is configured to pre-emptively replenish contracted block inventory by automatically generating pre-emptive bookings and holds when inventory of the contracted block has begun to diminish below a predefined threshold number of availability (e.g., below 2 rooms).

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. A dynamic graphical user interface rendering system for rendering a graphical user interface combining contracted reservation inventory and shared reserve block reservation inventory, the system including one or more processors and one or more memories coupled with the one or more processors, the one or more processors configured to:
maintain a trained machine learning model data architecture trained using iterative supervised training using an input data set to estimate time-based shifts in pricing and availability;
periodically receive, from one or more crossing network reservation management computing systems, time-stamped data sets indicative of availability characteristics at a first point in time corresponding to available reservation offer data objects;
operate the trained machine learning model architecture in an inference mode to determine at least a time-based price adjustment value and a time-based availability adjustment value;
record the time-based price adjustment value and the time-based availability adjustment value in an extended data structure having records corresponding to each type of available reservation;
receive a request to render the dynamic graphical user interface at a second point in time to determine inventory related to one or more contracted reservation offer object types;
determine, at least using the extended data structure, one or more adjusted availability values within a pre-defined adjusted price range for each of the one or more contracted reservation offer object types from the available reservation offer data objects; and
render, on the dynamic graphical user interface, one or more graphical interface elements indicative of a total availability of the one or more contracted reservation offer object types and a constrained set of available reservation offer data objects, constrained based on the one or more adjusted availability values.

2. The dynamic graphical user interface rendering system of claim 1, wherein the graphical interface elements are interactive graphical data interface elements which when coupled with a corresponding selection input, cause the one or more processors to generate a data message including a bid payload matching a selected contracted reservation offer object type, the bid payload configured for processing by a crossing network computer system for re-assigning an electronic reservation data object.

3. The dynamic graphical user interface rendering system of claim 1, wherein operation of the trained machine learning model data architecture in the inference mode includes providing a data set indicative of aggregated temporally proximate dynamic graphical user interface rendering system inputs across a corpus of user accounts as an input into the trained machine learning model data architecture for generating the time-based price adjustment value and the time-based availability adjustment value.

4. The dynamic graphical user interface rendering system of claim 3, wherein the data set indicative of aggregated temporally proximate dynamic graphical user interface rendering system inputs across a corpus of user accounts is utilized to determine a demand surge velocity value that is provided as an additional input for generating the time-based price adjustment value and the time-based availability adjustment value.

5. The dynamic graphical user interface rendering system of claim 1, wherein the one or more graphical interface elements include at least a first graphical representation of an availability of one or more contracted reservation offer object types, and a second graphical representation of the constrained set of available reservation offer data objects.

6. The dynamic graphical user interface rendering system of claim 4, wherein the one or more graphical interface elements include at least a third graphical representation of the available reservation offer data objects.

7. The dynamic graphical user interface rendering system of claim 5, wherein the second graphical representation is overlaid over the third graphical representation.

8. The dynamic graphical user interface rendering system of claim 1, wherein the extended data structure is updated periodically through periodic polling of the one or more crossing network reservation offer management computing systems.

9. The dynamic graphical user interface rendering system of claim 8, wherein the time-stamped data sets are time-stamped based on when the datasets are received from the one or more crossing network reservation offer management computing systems.

10. The dynamic graphical user interface rendering system of claim 1, wherein the one or more processors reside in a computer server operating in a data center, the computer server configured to host a web services platform rendering the graphical user interface.

11. A dynamic graphical user interface rendering method for rendering a graphical user interface combining contracted reservation inventory and shared reserve block reservation inventory, the method comprising:
maintaining a trained machine learning model data architecture trained using iterative supervised training using an input data set to estimate time-based shifts in pricing and availability;
periodically receiving, from one or more crossing network reservation management computing systems, time-stamped data sets indicative of availability characteristics at a first point in time corresponding to available reservation offer data objects;
operating the trained machine learning model architecture in an inference mode to determine at least a time-based price adjustment value and a time-based availability adjustment value;
recording the time-based price adjustment value and the time-based availability adjustment value in an extended data structure having records corresponding to each type of available reservation;
receiving a request to render the dynamic graphical user interface at a second point in time to determine inventory related to one or more contracted reservation offer object types;
determining, at least using the extended data structure, one or more adjusted availability values within a pre-defined adjusted price range for each of the one or more contracted reservation offer object types from the available reservation offer data objects; and
rendering, on the dynamic graphical user interface, one or more graphical interface elements indicative of a total availability of the one or more contracted reservation offer object types and a constrained set of available reservation offer data objects, constrained based on the one or more adjusted availability values.

12. The dynamic graphical user interface rendering method of claim 11, wherein the graphical interface elements are interactive graphical data interface elements which when coupled with a corresponding selection input, the method further comprising generating a data message including a bid payload matching a selected contracted reservation offer object type, the bid payload configured for processing by a crossing network computer system for re-assigning an electronic reservation data object.

13. The dynamic graphical user interface rendering method of claim 11, wherein operation of the trained machine learning model data architecture in the inference mode includes providing a data set indicative of aggregated temporally proximate dynamic graphical user interface rendering system inputs across a corpus of user accounts as an input into the trained machine learning model data architecture for generating the time-based price adjustment value and the time-based availability adjustment value.

14. The dynamic graphical user interface rendering method of claim 13, wherein the data set indicative of aggregated temporally proximate dynamic graphical user interface rendering system inputs across a corpus of user accounts is utilized to determine a demand surge velocity value that is provided as an additional input for generating the time-based price adjustment value and the time-based availability adjustment value.

15. The dynamic graphical user interface rendering method of claim 11, wherein the one or more graphical interface elements include at least a first graphical representation of an availability of one or more contracted reservation offer object types, and a second graphical representation of the constrained set of available reservation offer data objects.

16. The dynamic graphical user interface rendering method of claim 14, wherein the one or more graphical interface elements include at least a third graphical representation of the available reservation offer data objects.

17. The dynamic graphical user interface rendering method of claim 15, wherein the second graphical representation is overlaid over the third graphical representation.

18. The dynamic graphical user interface rendering method of claim 11, wherein the extended data structure is updated periodically through periodic polling of the one or more crossing network reservation offer management computing systems.

19. The dynamic graphical user interface rendering method of claim 18, wherein the time-stamped data sets are time-stamped based on when the datasets are received from the one or more crossing network reservation offer management computing systems.

20. A non-transitory computer readable medium storing computer interpretable instructions, which when executed by a processor, cause the processor to perform a dynamic graphical user interface rendering method for rendering a graphical user interface combining contracted reservation inventory and shared reserve block reservation inventory, the method comprising:
maintaining a trained machine learning model data architecture trained using iterative supervised training using an input data set to estimate time-based shifts in pricing and availability;
periodically receiving, from one or more crossing network reservation management computing systems, time-stamped data sets indicative of availability characteristics at a first point in time corresponding to available reservation offer data objects;
operating the trained machine learning model architecture in an inference mode to determine at least a time-based price adjustment value and a time-based availability adjustment value;
recording the time-based price adjustment value and the time-based availability adjustment value in an extended data structure having records corresponding to each type of available reservation;
receiving a request to render the dynamic graphical user interface at a second point in time to determine inventory related to one or more contracted reservation offer object types;
determining, at least using the extended data structure, one or more adjusted availability values within a pre-defined adjusted price range for each of the one or more contracted reservation offer object types from the available reservation offer data objects; and
rendering, on the dynamic graphical user interface, one or more graphical interface elements indicative of a total availability of the one or more contracted reservation offer object types and a constrained set of available reservation offer data objects, constrained based on the one or more adjusted availability values.
